(19) United States
(12) Patent Application Publication
(10) Pub. No.: US 2024/0282217 A1
(43) Pub. Date: Aug. 22, 2024

(54) WORK TRAINING SUPPORT SYSTEM AND WORK TRAINING SUPPORT METHOD

(71) Applicant: TOYOTA JIDOSHA KABUSHIKI KAISHA, Toyota-shi (JP)

(72) Inventors: Takashi Abe, Toyota-shi (JP); Hiroyuki Imai, Anjo-shi (JP); Yusuke Kobayashi, Toyota-shi (JP); Ryotaro Tanaka, Nisshin-shi (JP)

(73) Assignee: TOYOTA JIDOSHA KABUSHIKI KAISHA, Toyota-shi (JP)

(21) Appl. No.: 18/426,565

(22) Filed: Jan. 30, 2024

(30) Foreign Application Priority Data
Feb. 20, 2023 (JP) 2023-024009

(51) Int. Cl. G09B 19/24; G02B 27/01; G06F 3/01; G06T 19/00; G06T 19/20

(52) U.S. Cl. CPC G09B 19/24; G02B 27/0101; G02B 27/017; G06F 3/011; G06T 19/006; G06T 19/20; G02B 2027/0138; G02B 2027/014; G06T 2219/2012; G06T 2219/2016

(57) ABSTRACT

A work training support system includes: a detector detecting a movement of a tool during a first period, wherein the first period is a period in which an instructor performs work using the tool; a controller programmed to generate a first image using a detection result of the detector during the first period, wherein the first image represents the movement of the tool during the first period; and a head mounted display worn on a head of a trainee, wherein the head mounted display displays the first image in a field of view of the trainee during a second period, wherein the second period is a period in which the trainee performs the work using the tool.

### CROSS REFERENCE TO RELATED APPLICATIONS

This application claims priority to Japanese Patent Application No. 2023-024009, filed Feb. 20, 2023, the disclosure of which is incorporated by reference herein in its entirety.

### BACKGROUND

### Field

The present disclosure relates to a work training support system and a work training support method.

### Related Art

Using a model generated by machine learning, a technique for estimating how to act on events that have occurred during a work is known if a skilled worker (e.g., Patent Literature 1).

Patent Literature 1: WO-2019/093386-A

It is not easy to make a manual that can accurately convey a skill of a skilled worker to a trainee, so it requires trial and error to raise the skill of the trainee to the same level as the skill of the skilled worker. Therefore, a technique capable of efficiently increasing the proficiency of the trainee is desired.

### SUMMARY

One aspect of the present disclosure provides a work training support system. The work training support system includes: a detector detecting a movement of a tool during a first period, wherein the first period is a period in which an instructor performs work using the tool; a controller programmed to generate a first image using a detection result of the detector during the first period, wherein the first image represents the movement of the tool during the first period; and a head mounted display worn on a head of a trainee, wherein the head mounted display displays the first image in a field of view of the trainee during a second period, wherein the second period is a period in which the trainee performs the work using the tool.

### BRIEF DESCRIPTION OF THE DRAWINGS

FIG. 1 is an explanatory diagram schematically showing the configuration of a work training support system;

FIG. 2 is a flowchart showing the contents of a work training support method;

FIG. 3 is an explanatory view showing a state in which a first image is displayed on a display;

FIG. 4 is an explanatory view showing a state in which the first image and a second image are displayed on the display; and

FIG. 5 is an explanatory view showing a path of a tool in the first image and the second image.

### DETAILED DESCRIPTION

### A. First Embodiment

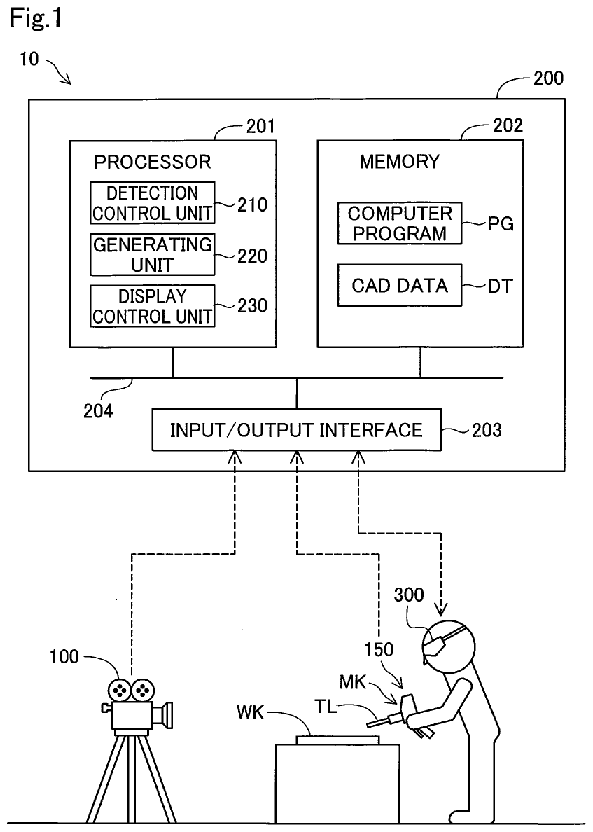

FIG. 1 is an explanatory diagram schematically illustrating the configuration of a work training support system 10 according to the first embodiment. The work training support system 10 is used for training for a work using a tool TL. In the present embodiment, the tool TL is a sealing gun for injecting a sealant, the work is a sealant coating operation in which a worker applies a sealant to a workpiece WK using the sealing gun. In the following description, the worker who serves as a role model of the work is called a instructor, and the worker who receives the training of the work is called a trainee. When the instructor and the trainee are explained without particular distinction, they are simply referred to as the worker.

The work training support system 10 includes a camera 100, a sensor 150, a controller 200, and a display 300. The camera 100, the sensor 150, and the display 300 are connected to the controller 200 through wired communication or wireless communication.

The camera 100 and the sensor 150 detect the movement of the tool TL during the work. The camera 100 is fixed at a position capable of photographing a state of the work. The camera 100 detects the position and pose of the tool TL in the movement of the tool TL by motion capture technique. In the present embodiment, the camera 100 detects the position and orientation of the tool TL by reading a marker MK fixed to the tool TL. The sensor 150 is fixed to the tool TL. The sensor 150 detects a predetermined movement of the tool TL other than the position and orientation of the tool TL. In the present embodiment, the seal gun, which is a tool TL, includes a lever and a nozzle, and injects the sealant from the nozzle at an injection amount corresponding to the grip amount of the lever. The sensor 150 includes a position sensor for detecting the position of the lever, in other words, the grip amount of the lever, and a pressure sensor for detecting the pressure applied to the nozzle when the nozzle is pressed against the workpiece WK. The detected movement of the tool TL is transmitted from the camera 100 and the sensor 150 to the controller 200. Incidentally, the camera 100 and the sensor 150 is sometimes referred to as a detector.

The controller 200 is a computer including a processor 201, a memory 202, an input/output interface 203, and an internal bus 204. The processor 201, the memory 202, and the input/output interface 203 are bidirectionally communicatively connected via the internal bus 204. The memory 202 stores the work training support program PG and the three-dimensional CAD data DT of the tool TL. The processor 201 functions as a detection control unit 210, a generating unit 220, and a display control unit 230 by executing the work training support program PG. The detection control unit 210 acquires the detection result of the movement of the tool TL during the work from the camera 100 and the sensor 150. The generating unit 220 uses the three-dimensional CAD data DT and the detected movement of the tool TL to generate an image that reproduces the movement of the tool TL during the work by a computer graphics technique. The display control unit 230 causes the display 300 to display an image generated by the generating unit 220.

The display 300 is mounted on the trainee's head. The display 300 is a transmission type head mounted display. The display 300 displays an image of a virtual space superimposed on a scene of a real space by an augmented reality technology. Specifically, the display 300 displays the image generated by the generating unit 220 in the view of the trainee. In the present exemplary embodiment, the display 300 includes a camera and various sensors, and performs alignment between the real space and the virtual space by detecting an object serving as a reference point within the real space. The display 300 is sometimes referred to as a head mounted display.

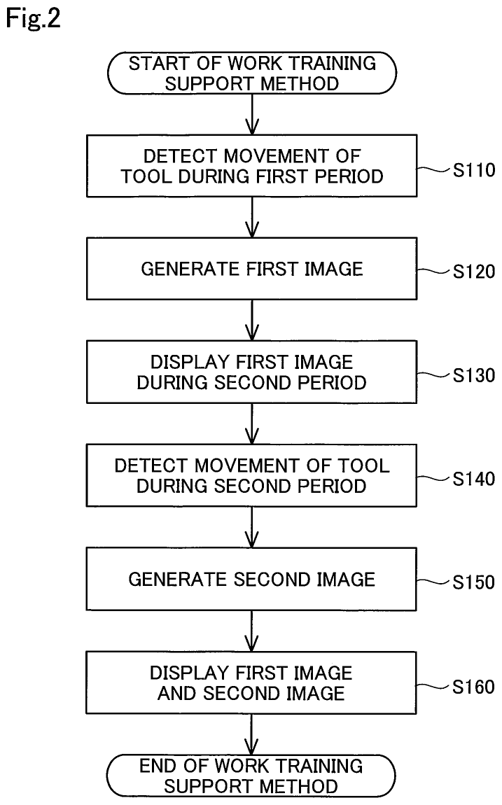

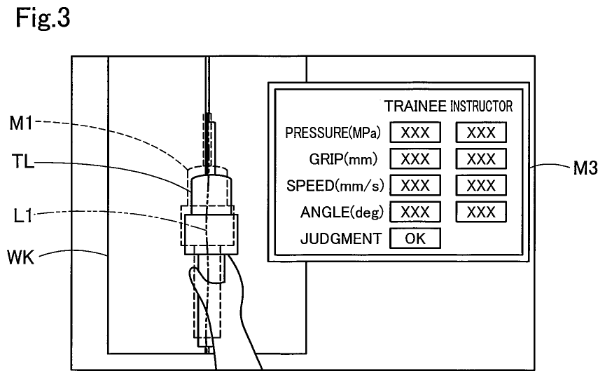

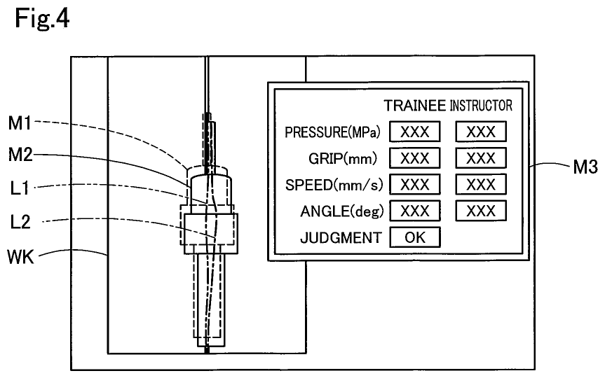

FIG. 2 is a flowchart showing the contents of a work training support method using the work training support system 10. FIG. 3 is an explanatory diagram illustrating a state in which a first image M1 is displayed on the display 300. FIG. 4 is an explanatory view illustrating a state in which the first image M1 and a second image M2 are displayed on the display 300. Once the work training support method are started, in S110, the instructor performs the work using a tool TL. In the following explanation, the period in which the instructor performs the work using the tool TL is referred to as the first period. The detection control unit 210 detects the movement of the tool TL during the first period using the camera 100 and the sensor 150. The detection control unit 210 stores the detection result of the movement of the tool TL during the first period in the memory 202.

In S120, the generating unit 220 generates a first image M1 representing the movement of the tool TL during the first period, that is, the movement of the tool TL due to the work of the instructor, using the three-dimensional CAD data DT stored in the memory 202 and the detected result of the movement of the tool TL during the first period. In the present embodiment, the first image M1, in addition to the movement of the tool TL during the first period, the path L1 of the movement of the tool TL during the first period is represented. The path L1 of the tool TL movement is, specifically, the path of the nozzle-tip movement.

In S130, the trainee performs the work using the tool TL while wearing the display 300. The content of the work carried out by the trainee in S130 is the same as the content of the work carried out by the instructor in S110. In the following explanation, the period in which the trainee performs the work using the tool TL is referred to as the second period. The display control unit 230 displays the first image M1 on the display 300 during the period from the beginning to the end of the second period. As shown in FIG. 3, the trainee sees the first image M1 displayed on the display 300 overlapping the scene of the real space that is visible through the display 300. Therefore, the trainee can perform the work while watching the scene of the real space and the first image M1. The trainee can mimic the motion of the instructor by moving the tool TL in the real space so as to trace the motion of the tool TL represented in the first image M1.

In S140, the detection control unit 210 detects the movement of the tool TL during the second period using the camera 100 and the sensor 150. Processing of S140 is executed concurrently with processing of S130. The detection control unit 210 stores the detection result of the movement of the tool TL during the second period in the memory 202. The generating unit 220 generates a third image M3 that side by side represents the measured values of the physical quantity measured using the camera 100 and the sensor 150 during the second period and the measured values of the physical quantity measured using the camera 100 and the sensor 150 during the first period, and the display control unit 230 displays the third image M3 in addition to the first image M1 on the display 300 during the period from the beginning to the end of the second period. The measurement during the second period is displayed on the third image M3 in real time. As shown in FIG. 3, in the third image M3, the pressure of the nozzle, the grip amount of the lever, the moving speed of the tool TL, and the rotational angle of the tool TL are represented. Pressure is measured using a pressure sensor, the grip amount of the lever is measured using a position sensor, the moving speed of the tool TL and the rotational angle of the tool TL is measured using the camera 100. The third image M3 further shows the pass/fail judgment of the work by the trainee. The generating unit 220 determines whether the work is passed or failed by the trainee and indicates a pass/fail determination in the third image M3. The generating unit 220, for example, when the difference between the measured value during the first period and the measured value during the second period is within a predetermined range, it is determined to pass, the difference between the measured value during the first period and the measured value during the second period is not within a predetermined range, it is determined to be rejected.

In S150, the generating unit 220 generates a second image M2 representing the movement of the tool TL during the second period, that is, the movement of the tool TL by the work of the trainee, using the three-dimensional CAD data DT stored in the memory 202 and the detected result of the movement of the tool TL during the second period. In the present embodiment, the second image M2, in addition to the movement of the tool TL during the second period, the path L2 of the movement of the tool TL during the second period is represented. The path L2 of the tool TL movement is, specifically, the path of the nozzle-tip movement. In order to easily distinguish the first image M1 from the second image M2, the generating unit 220 expresses the, color of the tool TL and the color of the path L2 in the second image M2 in a color differing from the color of the tool TL and the color of the path L1 in the first image M1.

In S160, the display control unit 230 causes the display 300 to display the first image M1 and the second image M2 superimposed on each other after the second period. The superimposing and displaying the first image M1 and the second image M2 on top of each other includes not only displaying the first image M1 and the second image M2 at the same position but also displaying the first image M1 and the second image M2 side by side. In the present exemplary embodiment, the display control unit 230 causes the display 300 to display the third image M3 in addition to the first image M1 and the second image M2. As shown in FIG. 4, the trainee can analyze the difference between the movement of the tool TL by the instructor and the movement of the tool TL by the trainee using the first image M1, the second image M2, and the third image M3 displayed on the display 300. After that, this work training support method ends.

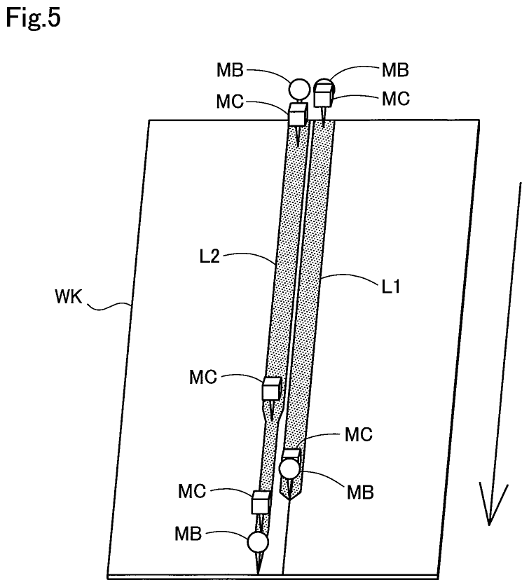

FIG. 5 is an explanatory diagram illustrating the path L1,L2 of the tool TL in the first image M1 and the second image M2. In the present exemplary embodiment, the thickness and the color of each part of the path L1,L2 are expressed by the thickness and the color according to the magnitude of the measurement of the sensor 150. Specifically, the thickness of each part of the path L1,L2 is expressed by the thickness corresponding to the size of the grip amount of the lever, the larger the grip amount of the lever, the path L1, L2 becomes thicker. Furthermore, on the path L1,L2, the point where the operation of gripping the lever has been started, and, a spherical mark MB is represented at a point where the operation of gripping the lever is completed, the grip of the lever is abruptly changed point cubic mark MC is represented. The color of each part of the path L1, L2 is represented by a color corresponding to the size of the nozzle pressing pressure, and the greater the nozzle pressing pressure, the lower the lightness of the color. In other words, the larger the pressure is, the darker the path L1,L2 is.

In the example shown in FIG. 5, the instructor opens the lever at once before the end of the sealant application range and continues to press the nozzle to the end to prevent the sealant from sticking out of the end. In contrast, the trainee has begun to open the lever in front of the position where the instructor opened the lever, but since the lever is fully opened at the end, the sealant easily sticks out from the end. The difference between the work of the instructor and the work of the trainee described above is expressed by the difference in the thickness and the colour of the path L1, L2 and the difference in the position of the mark MB, MC displayed together with the path L1,L2. Therefore, the trainee can easily recognize the difference between the work of the instructor and the work of the trainee by comparing the path L1, L2 and the mark MB, MC.

According to the work training support system 10 in the present embodiment described above, since the first image M1 is displayed on the display 300 during the second period, the trainee can perform the training of the work while watching the scene of the real space visible through the display 300 and the first image M1 displayed on the display 300. Since the motion of the tool TL by the instructor is represented in the first image M1, the trainer can experience the work technique of the instructor by moving the tool TL in the same way as the instructor. Therefore, it is possible to efficiently increase the proficiency of the trainee.

Further, in the present embodiment, the first image M1 represents the path L1 of the movement of the tool TL during the first period. Therefore, the trainee can perform the work while referring to the path L1 represented in the first image M1.

Further, in the present embodiment, in the third image M3, the real-time measured value measured using the camera 100 and the sensor 150 during the second period and the measured value measured using the camera 100 and the sensor 150 during the first period are represented side by side, so that the trainee can perform the work while referring to the measured value during the second period represented in the third image M3 and the measured value during the first period.

Further, in the present embodiment, after the work by the trainee is completed, the first image M1 and the second image M2 are displayed on the display 300 overlapping each other. Therefore, the trainee can analyze the difference between the movement of the tool TL by the instructor and the movement of the tool TL by the trainee by comparing the first image M1 displayed on the display 300 with the second image M2.

Further, in the present embodiment, the first image M1 represents the path L1 of the movement of the tool TL during the first period, and the second image M2 represents the path L2 of the movement of the tool TL during the second period. In addition, the thickness and color of each part of the path L1 and L2 are expressed according to the size of the measurement value measured using the sensor 150. Therefore, the trainee can easily recognize the difference between the movement of the tool TL by the instructor and the movement of the tool TL by the trainee.

### B. Other Embodiments

(B1) In the work training support system 10 of the first embodiment described above, the work training support system 10 includes the sensor 150. In contrast, the work training support system 10 may not include the sensor 150.
(B2) In the work training support system 10 according to the first embodiment described above, the first image M1 includes the path L1 of the tool TL during the first period, and the second image M2 includes the path L2 of the tool TL during the second period. In contrast, the first image M1 may not include the path L1 of the tool TL during the first period. The second image M2 may not include the path L2 of the tool TL during the second period.
(B3) In the work training support system 10 according to the first embodiment described above, the thickness of each part of the path L1,L2 is represented by a thickness corresponding to the measured value measured using the sensor 150, and the color of each part of the path L1,L2 is represented by a color corresponding to the measured value measured using the sensor 150. In contrast, at least one of the thickness and the color of each part of the path L1,L2 may be constant regardless of the measured value measured using the sensor 150.
(B4) In the work training support system 10 according to the first embodiment described above, the third image M3 is displayed on the display 300 during the second period. In contrast, the display 300, the third image M3 may not be displayed during the second period.
(B5) In the work training support system 10 according to the first embodiment described above, the process from S140 to S160 of the work training support methods may not be executed.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.
(1) In one aspect of the present disclosure, a work training support system is provided. The work training support system includes: a detector detecting a movement of a tool during a first period, wherein the first period is a period in which an instructor performs work using the tool; a controller programmed to generate a first image using a detection result of the detector during the first period, wherein the first image represents the movement of the tool during the first period; and a head mounted display worn on a head of a trainee, wherein the head mounted display displays the first image in a field of view of the trainee during a second period, wherein the second period is a period in which the trainee performs the work using the tool.

According to the work training support system of this form, the trainee can perform the work while watching the scene visible through the head mounted display and the first image displayed on the head mounted display. Therefore, it is possible to efficiently increase the proficiency of the trainee.
(2) According to the work training support system of the above aspect, the controller may generate the first image representing the movement of the tool during the first period and a path of the movement of the tool during the first period.

According to the work training support system of this form, the trainee can carry out the work while referring to the path represented in the first image.
(3) According to the work training support system of the above aspect, the detector may detect the movement of the tool during the second period, the controller may generate a second image using a detection result of the detector during the second period, wherein the second image represents the movement of the tool during the second period, and the head mounted display may display the first image and the second image superimposed on each other after the second period.

According to the work training support system of this form, the trainee can compare the movement of the tool by the instructor with the movement of the tool by the trainee using the first image and the second image displayed on the head mounted display.
(4) According to the work training support system of the above aspect, the controller may generate the first image representing the movement of the tool during the first period and a path of the movement of the tool during the first period, wherein at least one of a thickness and a color of each part of the path in the first image is represented depending on a first physical quantity related to the movement of the tool during the first period, and the controller may generate the second image representing the movement of the tool during the second period and a path of the movement of the tool during the second period, wherein at least one of a thickness and a color of each part of the path in the second image is represented depending on a second physical quantity related to the movement of the tool during the second period.

According to the work training support system of this form, the difference between the movement of the tool by the instructor and the movement of the tool by the trainee can be easily recognized by the trainee.
(5) According to the work training support system of the above aspect, the detector may detect the movement of the tool during the second period, the controller may generate a third image using a detection result of the detector during the first period and a detection result of the detector during the second period, wherein the third image represents a physical quantity related to the movement of the tool during the first period and a physical quantity related to the movement of the tool during the second period side by side, and the head mounted display may display the first image and the third image during the second period.

According to the work training support system of this form, the trainee can perform the work while referring to the first physical quantity relating to the movement of the tool during the first period represented in the third image and the second physical quantity relating to the movement of the tool during the second period.
(6) In one aspect of the present disclosure, a work training support method is provided. The work training support method includes: detecting, by a detector, a movement of a tool during a first period, wherein the first period is a period in which an instructor performs work using the tool; generating a first image using a detection result of the detector during the first period, wherein the first image represents the movement of the tool during the first period; and displaying, during a second period, the first image in a field of view of a trainee using a head mounted display worn on a head of the trainee, wherein the second period is a period in which the trainee performs the work using the tool.

According to the work training support method of this form, the trainee can perform the work while watching the scene visible through the head mounted display and the first image displayed on the head mounted display. Therefore, it is possible to efficiently increase the proficiency of the trainee.

The disclosure can be implemented in various forms other than the work training support system and the work training support method. For example, it can be realized in the form of a computer program stored on a computer readable recording medium.

What is claimed is:

1. A work training support system comprising:
a detector detecting a movement of a tool during a first period, wherein the first period is a period in which an instructor performs work using the tool;
a controller programmed to generate a first image using a detection result of the detector during the first period, wherein the first image represents the movement of the tool during the first period; and
a head mounted display worn on a head of a trainee, wherein the head mounted display displays the first image in a field of view of the trainee during a second period, wherein the second period is a period in which the trainee performs the work using the tool.

2. The work training support system according to claim 1, wherein
the controller generates the first image representing the movement of the tool during the first period and a path of the movement of the tool during the first period.

3. The work training support system according to claim 1, wherein
the detector detects the movement of the tool during the second period,
the controller generates a second image using a detection result of the detector during the second period, wherein the second image represents the movement of the tool during the second period, and
the head mounted display displays the first image and the second image superimposed on each other after the second period.

4. The work training support system according to claim 3, wherein
the controller generates the first image representing the movement of the tool during the first period and a path of the movement of the tool during the first period, wherein at least one of a thickness and a color of each part of the path in the first image is represented depending on a first physical quantity related to the movement of the tool during the first period, and
the controller generates the second image representing the movement of the tool during the second period and a path of the movement of the tool during the second period, wherein at least one of a thickness and a color of each part of the path in the second image is represented depending on a second physical quantity related to the movement of the tool during the second period.

5. The work training support system according to claim 1, wherein
the detector detects the movement of the tool during the second period,
the controller generates a third image using a detection result of the detector during the first period and a detection result of the detector during the second period, wherein the third image represents a physical quantity related to the movement of the tool during the first period and a physical quantity related to the movement of the tool during the second period side by side, and
the head mounted display displays the first image and the third image during the second period.

6. A work training support method comprising:
detecting, by a detector, a movement of a tool during a first period, wherein the first period is a period in which an instructor performs work using the tool;
generating a first image using a detection result of the detector during the first period, wherein the first image represents the movement of the tool during the first period; and
displaying, during a second period, the first image in a field of view of a trainee using a head mounted display worn on a head of the trainee, wherein the second period is a period in which the trainee performs the work using the tool.
